(19) United States
(12) Patent Application Publication
(10) Pub. No.: US 2010/0281095 A1
(43) Pub. Date: Nov. 4, 2010

(54) Mobile grid computing

(76) Inventors: Camille B. Wehner, San Francisco, CA (US); Michael F. Wehner, San Francisco, CA (US); Stephen A. Snow, Orinda, CA (US)

Correspondence Address: STEPTOE & JOHNSON LLP, 1330 CONNECTICUT AVENUE, N.W., WASHINGTON, DC, 20036, US

(21) Appl. No.: 12/662,519

(22) Filed: Apr. 21, 2010

Related U.S. Application Data
(60) Provisional application No. 61/202,933, filed on Apr. 21, 2009.

(51) Int. Cl. G06F 15/16

(52) U.S. Cl. 709/201

(57) ABSTRACT

Generally, a mobile grid computing system includes one or more mobile grid computing systems, a virtual computing server that controls distribution of data processing tasks across the mobile grid computing systems, and an accounting server in communication with the virtual computing server. Each of the mobile grid computing systems includes a grid computing server and mobile devices provisioned to perform data processing tasks received from the grid computing server and to communicate results from the performed data processing tasks to the grid computing server. The accounting server collecting information about the completion of data processing tasks by the virtual computing server.

### CLAIM OF PRIORITY

This application claims the benefit of U.S. Provisional Application No. 61/202,933, filed on Apr. 21, 2009, which is hereby incorporated by reference in its entirety.

### TECHNICAL FIELD

The present invention relates generally to systems and methods for mobile grid computing.

### BACKGROUND

Grid computing is the aggregation of computational resources to collectively process data in accordance with a set of instructions. For example, a diverse collection of geographically-distributed computers can be configured to operate in concert as a “virtual supercomputer,” capable of harnessing processing power from each participating computer to perform calculations.

The use of grid computing in academic research was pioneered by the SETI@home project of the University of California, Berkeley. SETI@home harnesses the processing power of millions of otherwise idle microprocessors to analyze radio telescope data, listening for signals that would provide some evidence of extraterrestrial technology. Volunteers download software to their computers to enable participation in this virtual supercomputer. Similar grid computing systems have been implemented for a variety of other research projects over a diverse range of fields of study including, for example, climate prediction, astrophysics, cryptography, and epidemiology, etc. SETI@home (and many other similar projects) are built upon the BOINC platform (“Berkeley Open Infrastructure Network Computing”), providing an open source grid computing platform.

In addition to use in computationally-intensive academic research projects, grid computing is also used by corporations to harness otherwise idle processor cycles across an enterprise. Commodity desktop computers organized to form a computing grid may provide equivalent processing power of a supercomputer costing millions of dollars. Such a grid may be used for a wide variety of computationally-intensive tasks including, for example, engineering design and verification, design simulation, graphical rendering, and the like.

### SUMMARY

Generally, a mobile grid computing system includes one or more mobile grid computing systems, a virtual computing server that controls distribution of data processing tasks across the mobile grid computing systems, and an accounting server in communication with the virtual computing server. Each of the mobile grid computing systems includes a grid computing server and mobile devices provisioned to perform data processing tasks received from the grid computing server and to communicate results from the performed data processing tasks to the grid computing server. The accounting server collecting information about the completion of data processing tasks by the virtual computing server.

In another general aspect, a method for use in a mobile grid computing system includes distributing client software to mobile devices of a service provider to enable participation in a mobile grid computing system, distributing data processing tasks to the mobile devices, receiving results of the data processing tasks from the mobile devices, collecting accounting information regarding the performance of the data processing tasks, and using the collected accounting information to determine a revenue share for the service provider based on the performance of the data processing tasks.

Further features of the present invention, as well as the structure and operation of various embodiments of the present invention are described in detail below with reference to the accompanying drawing.

### BRIEF DESCRIPTION OF THE DRAWINGS

FIG. 1A is a block diagram of a grid computing system harnessing the computational capabilities of mobile devices.

FIG. 1B is a diagram of an implementation of the grid computing system of FIG. 1A using mobile devices (such as cell phones) on a wireless communications network.

FIG. 2 is a block diagram of a virtual computing system to administer distribution of data processing tasks across one or more mobile grid computing systems.

FIG. 3 is a block diagram of a virtual computing system that includes an accounting server.

### DETAILED DESCRIPTION

Grid computing has enabled computationally-intensive research projects, and it has allowed corporations to harness otherwise idle processing power. However, home and office computers are not the only source of computational power—mobile devices such as, for example, cell phones, personal digital assistants, portable media players, and the like include increasingly powerful computational capabilities. We describe herein various techniques to harness otherwise idle computational capabilities of mobile devices using mobile grid computing, and new applications built on such mobile computing grids.

Architectural Overview

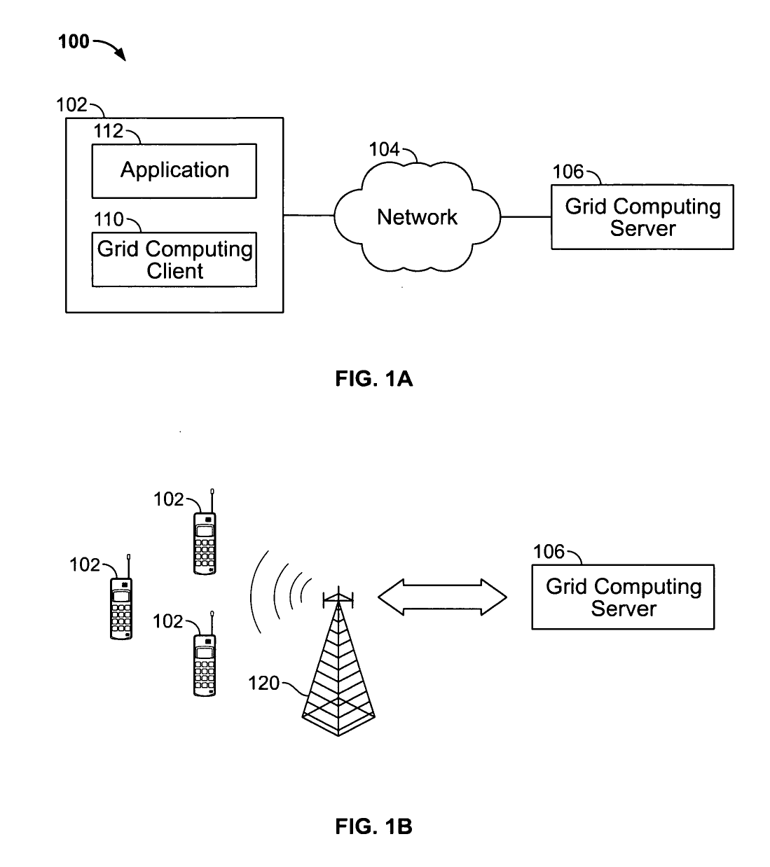

Referring to FIG. 1A, a mobile grid computing system 100 includes one or more mobile devices 102 connected through a network 104 to a grid computing server 106. The mobile devices 102 may include cell phones, personal digital assistants, portable media players, global positioning units, netbooks, iPads, smartbooks, slates, tablets, dongles, smart mobile devices, and the like having a microprocessor, digital signal processor, graphics processing unit, or other computational processing capability. The grid computing server 106 is responsible for assigning one or more tasks to a particular mobile device 102 and receiving the results of such tasks. In this manner, the grid computing server 106 manages the overall operation of the mobile grid computing system 100.

Due to the nature of mobile devices 102, they are unlikely to be available to the mobile grid computing system at all times. A cell phone, for instance, would be expected to perform its principal duties as a phone for the owner most of the day. However, cell phone users typically charge their phones at night, presenting an opportunity to harness their idle processing power. Accordingly, the grid computing server 106 may be implemented such that communication with mobile devices 102 is initiated by the mobile devices 102. For example, a mobile device 102 may contact the server 106 to request a computational task to be performed. The grid computing server 106 then assigns a task and communicates the task to the mobile device 102. The mobile device 102 receiving the task performs the task over a period of time. Upon completion, the mobile device 102 contacts the grid computing server 106 to upload task result(s) to the grid computing server 106 and to request a new task.

The grid computing system 100 may be implemented using BOINC, the Berkeley Open Infrastructure for Network Computing, by porting the BOINC client to each desired mobile device 102 platform. This may be accomplished, for example, in a manner similar to that used in Boincoid to port the BOINC client to the Android operating system used in the G1 mobile phone. BOINC core release version 6.6.17 (released March 2009) and associated documentation are hereby incorporated by reference in their entireties.

The mobile devices 102 are provisioned with two software components: grid computing client 110 and application 112. The grid computing client 110 communicates with the grid computing server 106 over the network 104 to, among other things, retrieve tasks to be performed and to report task results. The grid computing client 110 also controls the operation of application 112 which performs the computational tasks for a grid computing project. For example, if a mobile device 102 is participating in the SETI@home project, the grid computing client 110 would be configured to receive a task from the SETI@home server, and to coordinate execution of the received task using the application 112.

The grid computing server 106 may be implemented as a single device. However, in some implementations, it may be desirable to use multiple computers for reasons such as, for example, improved reliability, increased capacity, easier maintenance, etc. Such techniques are widely used in deploying commercial Internet services such as websites and can be used in deploying grid computing server 106.

FIG. 1B depicts a grid computing system 100 using mobile devices 102 on a mobile phone system. The mobile devices 102 wirelessly communicate with a mobile communication tower 120 providing access to the grid computing server 106. The grid computing server 106 may be located on a data network accessible by the mobile devices 102. For example, in some implementations it is desirable to place the grid computing server 106 on the Internet; however, in other implementations, the grid computing server 106 is placed on a private data communications network.

In some implementations, mobile devices 102 communicate with the grid computing server 106 using a 4G wireless network, providing a comprehensive and secure all-IP based solution capable of providing services such as IP telephony, ultra-broadband Internet access, gaming services and streamed multimedia to users.

Such a grid computing system 100 has many potential cost advantages over a traditional mainframe. First, the costs of the processors are borne by the phone owners. This alone may result in significant savings given that traditional massively parallel mainframes can cost tens of millions of dollars or more. Second, the cost of electricity is also borne by the phone owner. The cost of power is becoming an ever-increasing part of the operation of large computing facilities. Third, related infrastructure costs are reduced including, for example, the costs of cooling and maintaining the supercomputer.

Mobile Phone Grid Computing System

The architecture described above may be used to implement a grid computing system 100, provisioning mobile devices 102 of mobile communications subscribers as computational resources for grid computing. For example, a cell phone provider can provision the mobile devices of its subscribers in a computational grid. At present, many subscriber devices lack memory and/or processing capabilities to make them desirable for grid computing. Accordingly, participation may be limited to those devices meeting certain requirements, such as, for example, operating system, memory availability, processing capabilities, and the like.

Furthermore, a grid computing client 110 must be written for each supported platform. Thus, it is preferable to develop the grid computing client 110 based on the cost/benefit tradeoffs for a particular platform. For example, in one implementation, a grid computing client 110 is provided for supported smart phones (e.g., the Apple iPhone device, the T-Mobile G1 device, and the like).

The mobile grid system 100 may be provided by a service provider (e.g., AT&T, Sprint, T-Mobile, Verizon), or may be provided by a third-party in cooperation with one or more service providers. Provisioned mobile devices 102 retrieve tasks from a grid computing server 106 and perform those tasks, sending results back to the grid computing server 106.

The availability of mobile applications (“App(s)”) downloadable directly from major cellular smartphone manufacturers such as Blackberry (RIM), iPhone (Apple), and Palm makes possible the distribution of the mobile computing client 110 directly to participating mobile devices 102 as Apps.

Because tasks are typically computationally-intensive, they are likely to significantly reduce battery life. Furthermore, such computationally-intensive tasks are likely to impact device 102 performance if a user is attempting to simultaneously perform other processes. As both reduced battery life and performance impact are typically undesirable in a mobile device 102, the grid computing client 110 may be configured such that the application 112 only performs the assigned task at times selected so as not to impact a subscribers normal use of the mobile device 102. For example, the grid computing client 110 may be configured such that the application 112 only performs tasks while the mobile device 102 is charging. Furthermore, the grid computing client 110 also (or alternatively) may be configured to only perform tasks while the mobile device 102 is not being used for other purposes including, taking calls, texting, using the calendar, playing games, and the like.

A mobile device 102 may be provisioned by an administrator by sending an executable binary copy of the grid computing client 110 and one or more applications 112 to the mobile device 102. Ideal applications would be of a data type that can be easily broken into moderate size pieces. Each piece would be sent to and processed by a separate mobile device 102. A given mobile device 102 may be provisioned with multiple applications 112. The grid computing server 106 provides information associated with a particular task such that the grid computing client 110 can determine which application 112 to be used in performing the task. Applications 112 may be updated as needed to support new tasks, to fix bugs, to improve efficiency, etc.

In a preferred implementation, the operation of the mobile device 102 in a mobile grid computing system 100 would be invisible to subscribers, with computations taking place at times that would not impact the performance of the mobile device 102 for subscribers' intended uses.

The described grid computing system 100 includes communication across shared, and potentially insecure communications channels with mobile devices 102 in subscribers possession and physical control. There are many potential avenues for security breaches including the following: (i) mobile devices 102 may be breached; (ii) the grid computing server 106 may be breached; or (iii) the communications channel across network 104 may be breached. The system 100 may be made more secure through the use of data encryption such as OpenPGP. Public keys may be distributed to individual mobile devices 102 and used to encrypt results such that only the grid computing server 106 can decrypt and read the results. This would protect against a party receiving result sets by eavesdropping and reading communications across the network 104. Additionally, tasks may be randomly assigned to hinder the collection of information by a compromised mobile device 102. Additional security is provided by the fact that no particular phone has a large portion of the dataset. Small bits of information would be of little use to competitors.

Additionally, device security can be used in the mobile grid computing system 100. For example, application code sent to each mobile phone 102 may be sent in binary form to hinder viewing and modification. Any additional device security mechanisms, known to those skilled in the art, could be used.

In grid computing systems such as SETI@home, the integrity of results is a concern. It would be possible for a compromised mobile device 102 to submit flawed results that skew project results, or for a flawed port of application 112 to a new platform to unintentionally return incorrect results. Assurances of data integrity can be improved by duplicating effort and comparing results of the same task from multiple clients. For example, if the same task is assigned to three different mobile devices 102, and all three return the same result, there is a high degree of confidence in the integrity of those results. At the other extreme, a cluster of computers used by an enterprise in a computing grid may ensure integrity by controlling physical access to participating devices such that each task need only be performed once.

In the mobile grid computing system 100, data integrity depends, at least in part, on the integrity of subscriber devices. As devices are typically in the physical control of third-party subscribers, it is usually desirable to employ some redundancy to increase result integrity. If two separate result datasets generated by identical initial data agree, then data is unlikely to be corrupted. If they disagree, a third processing would be warranted to decide which was corrupted.

Whenever a mobile device 102 returns results that do not agree with one or more other mobile devices 102 processing the same task, such device can be marked as potentially corrupt. In some implementations, it is desirable to require that at least one mobile device 102 corroborate the result that is not marked as potentially corrupt. Thus, even if two mobile devices 102 return matching results, there may be insufficient assurance of data integrity if both devices 102 have previously participated in calculations resulting in divergent result datasets. A higher level of data integrity (if desired) may be achieved by assigning the same task to another mobile device 102 that is not marked as potentially corrupt. The grid computing server 106 can prevent unnecessary calculations by ensuring that a given task is assigned to no more than one potentially corrupt mobile device 102.

When a device 102 marked as potentially corrupt continues to return results that do not agree with those returned by other devices 102, the device may be deemed corrupt and stricken from participation in the mobile grid computing system 100.

A device 102 is flagged as potentially corrupt merely because it returned results different from those another device 102 returned as a result of the identical task. This does not mean that the device 102 is corrupt. Thus, the system 100 may provide some mechanism to clear devices 102 so that they are no longer flagged as potentially corrupt. This process may be automated—after a device flagged as potentially corrupt operates without disagreement with other devices 102 for a period, the flag may be cleared. The period may be a period of time such as, for example, one week, one day, one month, etc. Alternatively, the period may be the performance of a number of tasks (e.g., 5, 10, 30, etc.). If the mobile device 102 completes the period with no further incident (i.e., no further disagreements with other devices 102 performing the same task), then the flag may be cleared. Theoretically, an automated process could allow a truly corrupt device 102 to continue. As an alternative, a device 102 may be automatically cleared by reinstalling software.

In addition to automated processes, a device 102 that has been flagged as potentially corrupt or that has been stricken from the system 100 may be investigated by an administrator and manually re-provisioned at the option of the administrator.

As discussed above, it is desirable for a mobile device 102 to perform tasks so as not to affect the performance of the mobile device 102 for a subscriber. For a particular mobile device 102, a subscriber may charge the mobile device 102 each evening for approximately a 10-hour period. Thus, the phone is typically available during such 10-hour period for performing assigned tasks. It is desirable for the device 102 to complete tasks during such period. One measure that may be used to assign tasks of appropriate magnitude such that the tasks are likely to be completed before interruption is the mean time to interruption. This is likely to be several hours during the charging phase of a phone, particularly in the evenings or nighttime or “downtime” for that particular subscriber. The optimal time for our use of a particular mobile device 102 may be tracked and stored in order to make the best use of that particular mobile device 102. This time period will then determine the size of the task that is to be sent to a particular mobile device 102.

Assume that if the mobile device 102 is disconnected from the charger or if the owner actually uses the mobile device 102 (i.e., to make or answer a call), usage of the phone for performing tasks ceases. In some implementations, it is desirable for the size of the task sent to the phone should be such that multiple tasks would be completed during the charging period to decrease overall system latency. Consider as an example a mobile grid computing system 100 that attempts to assign 20 tasks that are typically completed during the mean time to interruption of a device. If the 20th task is interrupted, the results are either lost or may not be completed for a significant period of time. In this case 95% of the tasks complete on time, then the latency will be minimized. However, if tasks routinely fail to finish before interruption, then overall latency will be significantly increased. The granularity of the overall task determines the size of the problem and hence how fast a task could be completed. In general, it is preferable to break a problem into large numbers of small tasks. However, each task entails some overhead that becomes more and more significant as task sizes decrease. Thus, the particular application, the processing capabilities, the mean time to interruption, and other factors affect the desired task size for a particular implementation.

Virtual Supercomputer

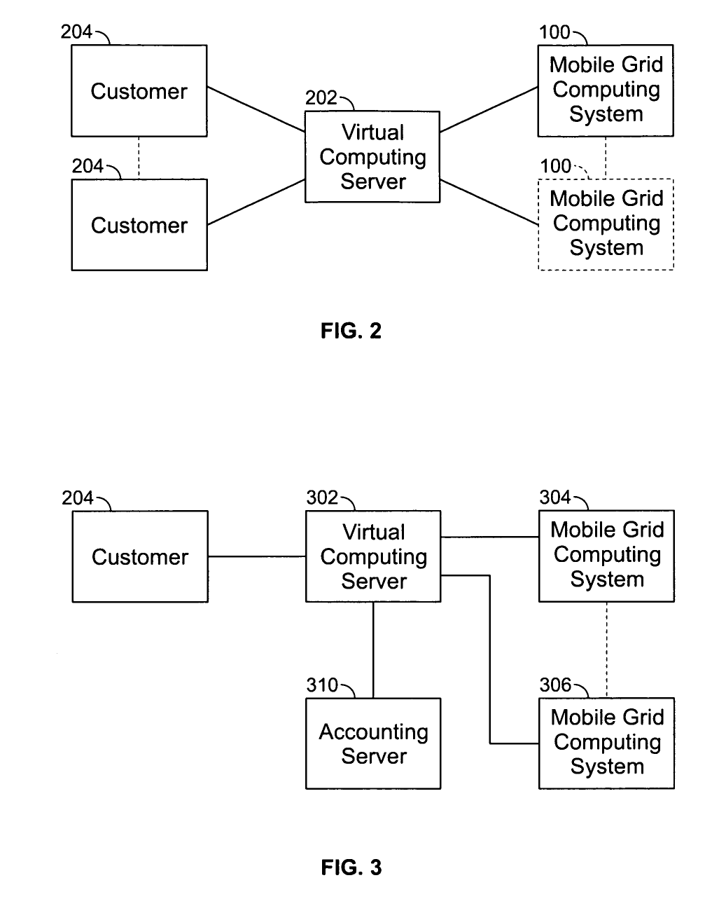

Referring to FIG. 2, the mobile computing grid 100 described above can be used to provide data processing capabilities to businesses, academic research projects, etc. A virtual computing server 202 allows customers 204 to access a virtual supercomputer formed of one or more mobile grid computing systems 100. This allows customers 204 to perform computationally-intensive tasks without significant capital expenditure or equipment leasing costs. Supercomputers can cost tens of millions of dollars, and can even run as high as $1B. Using the system shown in FIG. 2, customers can run applications using the virtual computing server 202 across one or more mobile grid computing systems 100 at significantly reduced costs.

Traditional datacenters are expensive in terms of Total Cost of Ownership (TCO). Due to market demands, IT managers are increasingly focused on reducing TCO, including the imputed lease cost or amortized cost of a facility, the depreciation and interest costs of hardware, and the cost of operating facilities, including electricity, repair and maintenance. Increasingly, these costs are encouraging savings through outsourcing using computation resources accessible through the Internet, commonly referred to as “cloud computing.” The virtual computing server 202 offers savings even greater than cloud computing offered by a conventional third-party datacenter.

Datacenters are inefficient when processors are not fully utilized. The mobile grid computing system 100 provides enhanced efficiency by using computation resources on an as-needed basis—those resources that are needed are provisioned and used, without necessitating costs associated with idle resources, including, for example, power consumption by idle processors.

A September 2009 paper by Google engineers, entitled “The Datacenter as Computer,” breaks down Total Cost of Ownership (TCO) based on their extensive review of third-party cost studies and internal Google data. According to the paper, hardware costs for a system with 8,000 servers at $4,000 per unit, each with power consumption of 500 W for a total of 4 megawatts power (MW), would total $32M for equipment. Hardware depreciation and interest costs, assuming 3.5 years average depreciation, are $2.40/W/year or $9.6 million per year for a 4 MW system. The facility housing that system would cost an average of $12 to $15/watt (W) of computing power or $48 to $60 million for the 4 MW system, and 80% of this facility cost is for heating/cooling infrastructure. Assuming depreciation over 12 years, the depreciation and interest cost (8%) of the facility is $1.92/W/year; or $7.7 million/year for 4 MW. Furthermore, average operating expenses for such a facility, excluding electricity, would typically be $0.48/W/year, or $1.9 million a year for a 4 MW datacenter. Server repair and maintenance is 5% of equipment capex or $1.6 million a year. Thus, the total cost of ownership for a 4 MW system, excluding electricity, would be approximately $20.8 million/year ($5.20/W).

Electricity would likely add an additional cost of about $1.70/W (assuming average commercial electricity rates of $0.10/kilowatt hour). Thus, A 4 MW center will consume $6.8 million of electricity per year of which only 30% to 40% is IT load, and about 40% to 50% of which is wasted due to low performance-to-power ratios. It is likely that these costs will continue to escalate, as the cost of U.S. electrical power has risen has risen 43% since 1990.

Furthermore, a 2006 study reports that in 85% of datacenters mechanical and electrical systems consume twice as much power as the computing load. In a typical raised-floor datacenter, chillers consume 30-50% of IT load, air conditioning (CRAC) consumes 10-30% of IT load, and the UPS system consumes 7-12% of power through AC-DC-AC conversion losses.

Finally, an analysis of performance-to-power ratios in datacenters running typical business applications shows that instead of on average running very close to peak load levels, servers actually spend most of the time within the 10-50% CPU utilization range. The Google study also seems to confirm this, stating as follows: “This activity profile turns out to be a perfect mismatch with the energy efficiency profile of modern servers in that they spend most of their time in the load region where they are most inefficient.”

The virtual computing server 202 allows customers 204 to access a virtual supercomputer formed of one or more mobile grid computing systems 100. Such a system offers customers 204 lower hardware and facilities cost. Customers 204 can significantly downsize computer center facilities by eliminating core processors. For example, a customer 204 realizing a 70% reduction in facilities could reduce the above cited annual total datacenter costs, excluding electricity, from $21 million to $6 million.

In addition, the use of mobile grid computing systems 100 improves performance-to-power ratios by accessing resources on as needed basis, thus increasing the “effective” utilization percentage well above that typically realized by datacenters. Furthermore, such a system can transfer electric power utilization from one region (such as a HP in New York where commercial power costs $0.15/kWh) to another, less expensive region.

Finally, a mobile grid computing system 100 using smartphone processors benefits as such devices are typically upgraded every two to three years. For example, processors have moved from a sub-500 MHz processor in 2007 to 600+ MHz processors in 2009 and will move to 1.0 to 1.5 GHz in 2010/2011.

As discussed above, energy costs (e.g., electric bills) can be enormous for a supercomputing project. However, using the system shown in FIG. 2, energy costs are borne by subscribers and not customers 204. While the added energy cost for a particular subscriber participating in the mobile grid computing system 100 is low, the aggregate energy costs across all participating subscribers would be significant. Using such a system as that shown in FIG. 2, a customer 204 may reduce energy costs significantly, as supercomputers can use $100,000 to $3M in power each year, and is expected to increase. Further, the overall electrical power consumption would be lower as cell phones processors are low power; while more cell phones would be needed to complete a task, less total power is required than for a supercomputer.

Simulation

One use of the mobile grid computing system 100 is the simulation of physical and/or mathematical systems, such as for example, Monte Carlo simulations. In Monte Carlo simulations, there is a need for random number generators (RNGs) that are both parallel (capable of executing on multiple processor threads simultaneously without coherence) and scalable (capable of running on a large number of processors). Modelers are aware of the danger of coherence in models that occurs when simulations run on HPC's, even with several thousand processors, produce results with high degrees of periodic correlation between sections of output, effectively reducing multiple runs to just replications of a small number of runs. In the worst case, this can reduce the number of trials to just one. This is dangerous since the coherence is often masked in the high dimensionality of the problem and is not easily noticed.

By accessing 100,000's to millions of processors, each in a different device, it is possible to reduce the risk of coherence in simulations. These simulations may include, for example, models of stock markets and exchange rate fluctuations, models of composition variations of heterogeneous materials for geophysics and oil exploration, and models of bioinformatics such as gene sequencing studies.

Tradable Electricity Credits or Rights

As discussed above, the electricity costs of operating a supercomputer are significant. Costs of energy production vary from location to location, as does supply. In some locations, electricity is a scarce resource, especially during periods of peak usage (e.g., warm summer days). For various reasons, including cost, environmental impact, and supply limitations, it may be desirable to shift consumption to another location. One way to encourage better usage of limited resources is for the government to grant limited rights to such resources.

Water is recognized as a scarce resource and, in some states, is approaching crisis levels. In California, the bellwether state for environmental regulation, Governor Schwarzenegger has called for a 20% reduction in per capita water use by 2030. Making water expensive is seen as the best way to force conservation. Legislation has been adopted that will require escalating tiered pricing on all water customers, thus making it very attractive to save water. A Pacific Institute “California Water 2030” study forecasts that a 41% increase in water prices will drive a 20% decrease in water use, whereas a 20% price increase will only drive a 5% water savings; this and other conservation measures will result in total water use decreasing over the next 20 years.

In California, state and local government have implemented a range of incentives to install water saving devices on all new homes and large incentives to replace older, inefficient devices. Rebates and vouchers for such water saving technologies can reach 50% to 100% of the cost. Furthermore, there are mandates forcing adoption of these technologies in all new homes by 2010.

With the water shortage has come a healthy market for water rights as demand for water in developing areas has exceeded supply. All developers of larger parcels in California are now required to “secure their own water”—i.e. find a place to buy it. This has forced developers to buy water rights from farmers—the price has escalated from $4,000/acre foot ten in the early 1990's to $45,000 in 2004.

The National Renewable Energy Laboratory study (February 2006) titled “Regional Difference in Price-Elasticity of Demand for Energy” reports a close correlation between price and demand. Inflation adjusted prices for electricity dropped from 11 cents/kwh to 8 cents/kwh between 1983 and 2003 and total national demand rose from 0.65 billion to 1.3 billion kwh over that period. This report looked at the impacts of recent price increases in various regions shows that price elasticity is low for residential users (0.32) but high for commercial users (0.97). This confirms our assumption that corporations will be looking for ways to dramatically cut electrical power use.

Carbon emission cap and trade regulations will dramatically drive up the cost of electricity in areas where coal is used to generate power. These areas are primarily in the East, South and Midwest. In those areas where there are a great many corporate and public supercomputers, the cost of running that equipment will escalate sharply. In the USA, if government forces further electric utilities to go to tiered pricing to “punish” large users, interest in using more efficient computing will further escalate.

Once electricity becomes more of a scarce and expensive commodity and cap and trade rules come into effect, there will be trading in electricity rights between electricity users. This market will mimic the carbon credit markets. Money will be made by those who can conserve electricity. Such markets, where they exist today (e.g., in Europe and Asia) are already very robust.

Just as today systems are in place to encourage reduction in carbon emissions, it is likely that an analogous system will be used with respect to power consumption. Just as businesses now trade carbon credits, water rights, and the like, it is expected that businesses will one day also trade rights to power consumption. If a corporation is able to eliminate $100,000 to $1 M in annual power consumption, they may receive credits for this and thereby have a new, valuable asset that may be used for other purposes, traded, or sold. They are likely to be able to offset other corporate electricity costs, and rights to sell excess, “grandfathered” usage amounts to other entities that need more electricity. In California, water rights belonging to farmers along the North-South water canals have been sold to developers with projects located within a hundred miles of the canal. These water rights increased from $4,000/acre foot in the 90's to more than $40,000 in recent years.

In some implementations, the architecture incorporates a system to identify, initiate, process, track and record both carbon and renewable energy credit trades. The European Union (EU) ETS (Energy Trading Scheme) is the primary trading market for carbon credits under the mandatory Kyoto Accords. A carbon credit, called a CER (Certified Emission Reduction), is equivalent to one metric ton of CO₂ Buyers of CER's are companies that exceed their EU-ETS allowable CO₂ output. Sellers are either companies that have reduced their output of CO₂ below their allowable limit or companies that sequester CO₂ by planting rain forests or reduce CO₂ by using renewable power sources.

Voluntary trading of Renewable Energy Credits (REC) is accomplished through privately held trading companies such as Climate Exchange, Elements Markets LLC, and Nymex Green Exchange. An REC is traded primarily in the US and is the equivalent of one megawatt hour (MWh) of clean, non CO₂ producing electricity. Buyers are environmentally conscious companies that wish to be “carbon neutral” or companies that have failed to reach new government mandated limits for adoption of renewable energy sources. The market-driven climate exchanges that developed the new REC instruments are planning to create other forms of tradable credits that will encourage energy conservation and reduction of greenhouse gases.

The mobile grid computing system 100 includes a component to track energy credits so that they may be realized by customers. This component collects data that can be used to determine relevant information regarding energy consumed by a customer in relation to the electricity that would have been otherwise consumed. It also collects relevant information regarding carbon outputs that result from a customer's use of the grid computing system in relation to the carbon outputs that would otherwise have been created.

For example, in one implementation, the system tracks customers usage of the mobile grid computing system 100. Each of the customer's supercomputers that is displaced by a mobile grid becomes a “project” with a project number. Data entered for that project includes the customer's name and contact, the location and capacity of the old supercomputer (e.g., terabytes of computing power) and historical annual power consumption. Also entered is information on the customer's local power company; location and key contact persons, the CO₂ output per megawatt record of that power plant, and the computed estimate of the total CO₂ output during the prior year for the old supercomputer. In addition, the project file includes particulars on the replacement mobile grid computing technology, including the consumption of electricity in MWh, cost per MWh in the grid computing network, the estimated CO₂ per MWh and the annual totals for MWH and metric tons of CO₂ output.

In this implementation, each customer (the donor) has a contract with the mobile grid computing entity (the aggregator) that defines what percent of the carbon or reduced energy credits earned for each project will be owned by each party.

Trading carbon or electricity certificates can be facilitated through membership in various climate exchanges. The mobile grid computing system 100 serves as an “aggregator” under exchange rules and submits projects from its customers who become the “donors”. This relationship enables the grid computing entity's own trading system to interface with the climate trading exchange's internet-based, electronic trading system for submission of bids and offers for anonymous trades executed with price and time priorities. Each project is approved separately by the exchange. Trades result in electronic bilateral agreements between member companies. Contract settlements occur on the next business day via wire transfers. The mobile grid computing entity's trading system stores the records of all transactions with each climate exchange and the respective buying and selling parties. The system interfaces with the grid computing entities' computerized accounting system.

The mobile grid computing company receives the payments from the climate exchange for sales of credits and the grid computing entity remits to the customer its pre-negotiated percent of the proceeds. All such transactions are recorded in the system and accessed by the customer relationship and accounting systems.

In some embodiments of this process, the electrical power company may become one of the parties, possibly as a donor and the split of revenues may include three parties or more. In some embodiments, trades may involve both a US-based climate exchange and a European or Asian exchange, where an offshore company owns the older, decommissioned supercomputer.

Currently several financial services entities work with both carbon reduction project developers and buyers of carbon credits to offer creative financing options to project developers. These financing tools are offered for traditional projects that reduce carbon emissions through a variety of means from sequestering carbon via reforestation to capturing methane from biological waste for energy production. The financial service entities structure forward selling of carbon emission reduction streams through long term Emission Reduction Purchase Agreements (ERPAs) or Verified Emission Reduction Purchase Agreements (PERPA's) at fixed prices, sheltering project developers from long term price fluctuations.

Once carbon trading markets adopt an expanded definition of carbon credits to include technologies that produce measurable and verifiable carbon emissions reductions from reduced electricity consumption, financial service entities can structure incentives for the development and use of a mobile grid computing system 100. Such incentives can be, for example, based on forward selling carbon credits (CER's) or renewable energy credits (REC's). An accounting service can track and report energy savings, CER's and REC's for financial service entities and customers.

Going Green

The environmental impact of power generation varies from geographical area to geographical area. In some locations, the environmental impact of power generation necessary to power a supercomputer is great, while in other areas relying more heavily on renewable resources, the impact would be far less. Customers 204 can use the virtual computing server 202 to transfer energy production from a high-impact geographical location to a low-impact geographical location.

Referring to FIG. 3, a virtual computing server 302 provides access to multiple mobile grid computing systems 304 and 306, each having differing environmental impacts. The customer 204 selects a desired environmental impact profile from a list of possible profiles. For example, possible profiles may include the following: (i) all renewable; (ii) green; (iii) lowest cost. If a customer 204 selects the “all renewable” profile, the virtual computing server 302 ensures that all tasks are assigned to mobile grid computing systems 304 and 306 that use only renewable power. For example, if a community generates the majority of its power from wind, waves, or solar energy sources, then the mobile devices 102 operating in those areas are powered by renewable energy sources. Each mobile grid computing system 304 and 306 corresponds to a predetermined energy profile based on power generation and utilization in such geographical area. If power is generated predominantly from clean coal and nuclear plants, then a system 304 or 306 could be assigned to the “green” profile. By assigning profiles, customers 204 can tailor energy consumption to be more environmentally responsible.

Corporations covet a LEED (Leadership in Energy and Environmental Design) certification from the U.S. Green Building Council. These certifications are based on a number of points garnered by changing facility use of power and water. New technologies and operating procedures qualify for LEED points as they are proven effective. By reducing energy consumption in high-impact communities, and shifting power consumption to lower-impact communities or to communities using all renewable resources, the system set forth in FIG. 3 may help companies obtain LEED points toward certification of their corporate facilities.

The accounting server 310 tracks usage of the mobile grid computing systems 302 and 304 by customers 204 through the virtual computing server 302. Customers 204 usage is associated with corresponding environmental profiles such that customers 204 may be charged for use of the virtual computing environment. Each profile would entail different resource utilization costs. For example, usage of the “renewable” profile systems could be billed at a higher rate than the other available profiles.

Service Provider Revenue Share

The system shown in FIG. 3 also may be used to account for revenue shares with wireless service providers. The accounting server 310 receives information from the virtual computing server 302 indicating the actual utilization of each mobile grid computing system 304 and 306. In this implementation, each system 304 and 306 is associated with a particular provider. Revenue is shared based on payments from corporate supercomputer users for use of processing capabilities of mobile grid computing systems 304 and 306. Revenue share may be calculated based on any measurable value including, for example, throughput (bytes), tasks completed, number of participating subscribers, average floating point operations per second completed, and the like.

A participating service provider may reduce costs by participating in a virtual computing system such as that described in FIG. 3. This may provide significant competitive advantage. Carriers also stand to gain financially by participating in the trading for credits in the markets developed under this plan. Furthermore, cell carriers may gain public recognition as an environmental steward from participating in shifting power consumption to areas where power generation has less environmental impact.

Promoting Participation

Subscribers owning a mobile device 102 participating in a mobile grid computing system 100 may be further encouraged to participate through a loyalty or rewards program. Consider, for example, the system shown in FIG. 1A. The grid computing server 106 tracks the assignment and completion of tasks for participating mobile devices 102. As part of the program, subscribers have the ability to gain loyalty “points” or “currency” for participating in the program. These points could then be used to “trade” or “purchase” items (such as ring tones, music, TV show or movie downloads.)

In some implementations, participating is encouraged through a partner entity, or by offering services on behalf of a partner entity. A partner entity may be, for example, a university, a nonprofit environmental or scientific entity, or other nonprofit or for-profit enterprise. The Partner Entity could encourage participation by promoting its use to its alumni and/or supporters.

In another implementation, customers of a mobile grid computing system are encouraged to participate by distributing mobile phones to employees such that the mobile phones participate in the mobile grid computing system. Consider, for example, a large bank that is a customer of a mobile grid computing system. The bank can distribute smartphones to its employees, and the smartphones can be configured to participate in the mobile grid computing system. This provides many benefits including at least the following: ensuring quality and uniformity in participating phones, more predictable use profiles, greater control over security, and known costs of service per user. In return for the customers' participation in the grid, they may receive incentives such as a discount on their grid computing costs.

One skilled in the art will appreciate that processes, machines, manufactures, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A mobile grid computing system comprising:
one or more mobile grid computing systems, each of the mobile grid computing systems including a grid computing server and a plurality of mobile devices provisioned to perform data processing tasks received from the grid computing server and to communicate results from the performed data processing tasks to the grid computing server;
a virtual computing server that controls distribution of data processing tasks across the one or more mobile grid computing systems; and
an accounting server in communication with the virtual computing server, the accounting server collecting information about the completion of data processing tasks by the virtual computing server.

2. The mobile grid computing system of claim 1, wherein the plurality of mobile devices includes a mobile phone.

3. The mobile grid computing system of claim 2, wherein the mobile phone is configured to perform the received data processing tasks only while the mobile phone is charging.

4. The mobile grid computing system of claim 1, wherein the grid computing server ensures the integrity of results from performed data processing tasks.

5. The mobile grid computing system of claim 1, wherein the accounting server tracks energy credits.

6. A method for use in a mobile grid computing system, the method comprising:
distributing client software to a plurality of mobile devices of a service provider, the client software usable by the plurality of mobile devices to enable participation in a mobile grid computing system;
distributing data processing tasks to the plurality of mobile devices for performance using the client software;
receiving results of the data processing tasks from the plurality of mobile devices;
collecting accounting information regarding the performance of the data processing tasks; and
using the collected accounting information to determine a revenue share based on the performance of the data processing tasks.

7. The method of claim 6, wherein the service provider is a wireless service provider.

8. The method of claim 6, wherein the accounting information includes one or more from the group consisting of:
number of tasks completed;
data throughput;
number of participating mobile devices; and
average floating point operations per second completed.

9. The method of claim 6, wherein the plurality of mobile devices includes a mobile phone.
